(19) United States
(12) Patent Application Publication
(10) Pub. No.: US 2012/0212780 A1
(43) Pub. Date: Aug. 23, 2012

(54) PRINTING APPARATUS AND ELECTRONIC DEVICE

(75) Inventor: Kazushi Fujimoto, Kawaguchi-shi (JP)

(73) Assignee: CANON KABUSHIKI KAISHA, Tokyo (JP)

(21) Appl. No.: 13/369,896

(22) Filed: Feb. 9, 2012

(30) Foreign Application Priority Data
Feb. 21, 2011 (JP) 2011-035178

(51) Int. Cl. G06F 3/12

(52) U.S. Cl. 358/1.15

(57) ABSTRACT

In serial data transfer using an LVDS, when the power-down signal of a low voltage differential buffer is controlled using a clock signal used for the transfer as the operation clock of a reception side circuit, the power-down signal and reset signal need to be controlled properly; otherwise, an apparatus operation may become unstable due to an unstable clock signal. To solve this problem, the power-down signal of the low voltage differential buffer is controlled in consideration of the logical condition for a reset signal for the ASIC of a printhead and a communication signal. The clock signal can be supplied into the printhead to de-assert reset of the ASIC without using any dedicated control signal and delay circuit at the timing when an output from the low voltage differential buffer stabilizes.

### BACKGROUND OF THE INVENTION

1. Field of the Invention

The present invention relates to a printing apparatus and electronic device. Particularly, the present invention relates to a printing apparatus and electronic device which transmit a data signal using an LVDS (Low Voltage Differential Signal).

2. Description of the Related Art

Recently, inkjet printing apparatuses, which have been used widely, are achieving higher-resolution image printing by decreasing the ink discharge amount per dot while increasing the integration density of nozzles for discharging an ink droplet.

To obtain a higher-quality image, a variety of techniques have been implemented such that inks of four basic colors (cyan, magenta, yellow, and black), light color inks prepared by decreasing the densities of these inks, and inks of spot colors such as red, green, and blue are discharged simultaneously. It is becoming possible to satisfactorily suppress even a decrease in printing speed which may occur along with improvement of the image quality, by increasing the number of printing elements, increasing the driving frequency, and introducing a technique such as reciprocal printing of the printhead.

In the printhead including many printing elements, the data amount to be transferred in a unit time increases as the driving frequency increases. The increase in data amount is coped with by adding a signal line for data signal transfer or increasing the transfer speed itself. Further, there have recently been proposed many methods such as a high-speed data transfer method while suppressing an increase in the number of signal lines by combining the serialization technique and low voltage differential signaling.

However, several problems arise in a printing apparatus which employs a data transfer technique using an LVDS (Low Voltage Differential Signal) as described in, for example, Japanese Patent Laid-Open No. 2008-100483. Data transfer using a low voltage differential signal requires low voltage differential buffers on the driver side and receiver side, respectively. Generally in a shipping test for an IC including a low voltage differential buffer, a power-down terminal is prepared to prevent a breakthrough current from flowing inside from the low voltage differential buffer.

However, an output from the low voltage differential buffer sometimes becomes unstable depending on the state of the power-down terminal. Particularly in a circuit which operates based on, as a basic clock, a serial clock for serial transmission using the low voltage differential buffer to reduce the number of connection terminals, if the power-down terminal and the reset terminal of the circuit are not controlled properly, reset cannot be de-asserted in a stable clock state. This may lead to an operation error of the apparatus.

To properly control the power-down signal and reset signal, a dedicated terminal and delay circuit need to be arranged. However, this arrangement itself requires an additional signal. To satisfy this requirement, a delay element and delay circuit need to be introduced, but this increases the number of gates of the circuit, the circuit scale, and thus the cost. The same problem occurs not only in the printing apparatus but also in other devices.

### SUMMARY OF THE INVENTION

Accordingly, the present invention is conceived as a response to the above-described disadvantages of the conventional art.

For example, a printing apparatus and electronic device according to this invention are capable of transmitting a signal to a printhead using a low voltage differential signal which operates stably with a simple arrangement.

According to one aspect of the present invention, there is provided a printing apparatus comprising: a printhead which is connected to the printing apparatus via a communication line, a reset signal line, and a differential signal line, the printhead including a printing element, control circuit for controlling driving of the printing element, arithmetic circuit for performing logical calculation based on a signal received via the communication line and a signal received via the reset signal line, and generation circuit for supplying a clock signal to be transferred to the control circuit based on a differential clock signal received via the differential signal line and an output from the arithmetic circuit; a first transmission unit configured to output a control signal in a first predetermined period before transmitting data to the control circuit via the communication line; and a second transmission unit configured to transmit a reset signal for de-asserting a reset state of the control circuit, via the reset signal line a second predetermined period after the first transmission unit outputs the control signal.

According to another aspect of the present invention, there is provided an electronic device comprising: a driving unit which is connected to the electronic device via a communication line, a reset signal line, and a differential signal line, the driving unit including a driving element, control circuit for controlling driving of the driving element, arithmetic circuit for performing logical calculation based on a signal received via the communication line and a signal received via the reset signal line, and generation circuit for supplying a clock signal to be transferred to the control circuit based on a differential clock signal received via the differential signal line and an output from the arithmetic circuit; a first transmission unit configured to output a control signal in a first predetermined period before transmitting data to the control circuit via the communication line; and a second transmission unit configured to transmit a reset signal for de-asserting a reset state of the control circuit, via the reset signal line a second predetermined period after the first transmission unit outputs the control signal.

The invention is particularly advantageous since neither a dedicated terminal nor delay circuit need be arranged to control the power-down signal of a low voltage differential buffer, and the number of connection terminals with the printhead and the circuit scale of the head substrate can be reduced.

Further features of the present invention will become apparent from the following description of exemplary embodiments (with reference to the attached drawings).

### BRIEF DESCRIPTION OF THE DRAWINGS

FIG. 1 is a perspective view showing the main mechanism of an inkjet printing apparatus as a typical embodiment of the present invention.

FIG. 2 is a block diagram showing the relationship between the control substrate of a printing apparatus main body and a printhead.

FIG. 3 is a block diagram showing the detailed arrangement of control regarding transmission/reception of an LVDS between the printing apparatus and the printhead.

FIG. 4 is a timing chart showing signals transmitted/received via a data transfer line, reset signal line, and communication line, and a power-down signal.

### DESCRIPTION OF THE EMBODIMENTS

An exemplary embodiment of the present invention will now be described in detail in accordance with the accompanying drawings. Note that an arrangement to be disclosed in the following embodiment is merely illustrative, and the present invention is not limited to the illustrated arrangement. The present invention is applied to even another electronic device.

In this specification, the terms “print” and “printing” not only include the formation of significant information such as characters and graphics, but also broadly includes the formation of images, figures, patterns, and the like on a print medium, or the processing of the medium, regardless of whether they are significant or insignificant and whether they are so visualized as to be visually perceivable by humans.

Also, the term “print medium” not only includes a paper sheet used in common printing apparatuses, but also broadly includes materials, such as cloth, a plastic film, a metal plate, glass, ceramics, wood, and leather, capable of accepting ink.

Furthermore, the term “ink” (to be also referred to as a “liquid” hereinafter) should be extensively interpreted similar to the definition of “print” described above. That is, “ink” includes a liquid which, when applied onto a print medium, can form images, figures, patterns, and the like, can process the print medium, and can process ink. The process of ink includes, for example, solidifying or insolubilizing a coloring agent contained in ink applied to the print medium.

Further, a “printing element” (to be also referred to as a “nozzle”) includes an ink orifice or a liquid channel communicating with it, and an element for generating energy used to discharge ink, unless otherwise specified.

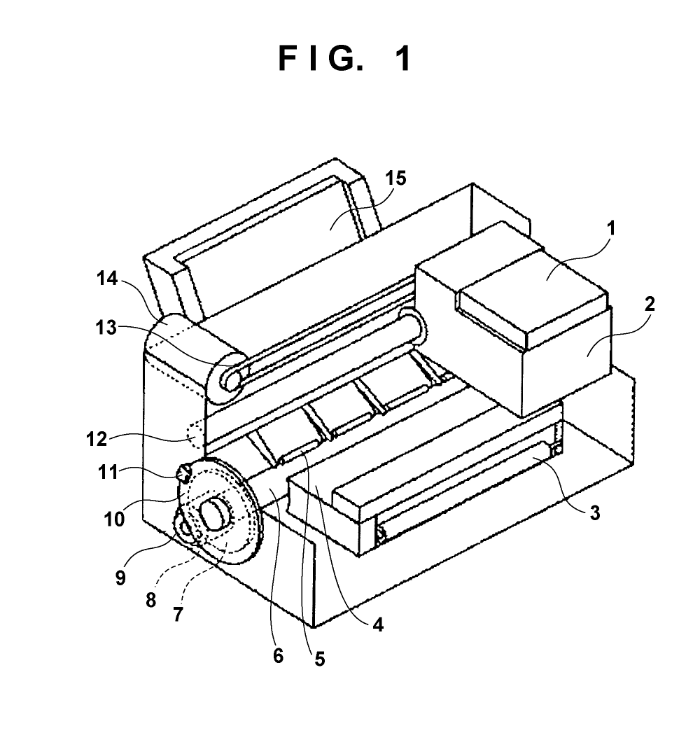

FIG. 1 is a perspective view showing the main mechanism of an inkjet printing apparatus (to be referred to as a printing apparatus) as a typical embodiment of the present invention.

Referring to FIG. 1, a carriage 2 which supports an inkjet printhead (to be referred to as a printhead) 1 including an array of nozzles for discharging ink reciprocally moves in the scanning direction perpendicular to the printing medium conveyance direction, printing on a printing medium. The carriage 2 is fixed to a belt 13, and slidably attached to a shaft 12. As a carriage motor 14 moves the belt 13, the carriage 2 attached to the belt 13 also moves.

A paper discharge roller 3 conveys the printed printing medium to outside the apparatus. A platen 4 is arranged below a surface opposite to the printing surface of a printing medium to face the ink discharge surface of the printhead 1. In printing, a printing medium 15 such as printing paper is pressed by a paper press roller 5, and conveyed along with the progress of printing by a conveyance roller 6 which receives the driving force of a conveyance motor 8 via a conveyance gear 7 and conveyance motor gear 9.

An encoder film 10 is attached around the conveyance gear 7, and rotates in synchronism with rotation of the conveyance motor 8. An encoder sensor 11 is used to detect slits formed in the encoder film 10 at a predetermined interval, generating an encoder signal. Based on this signal, the conveyance position of the printing medium 15 is detected, and the print timing is generated.

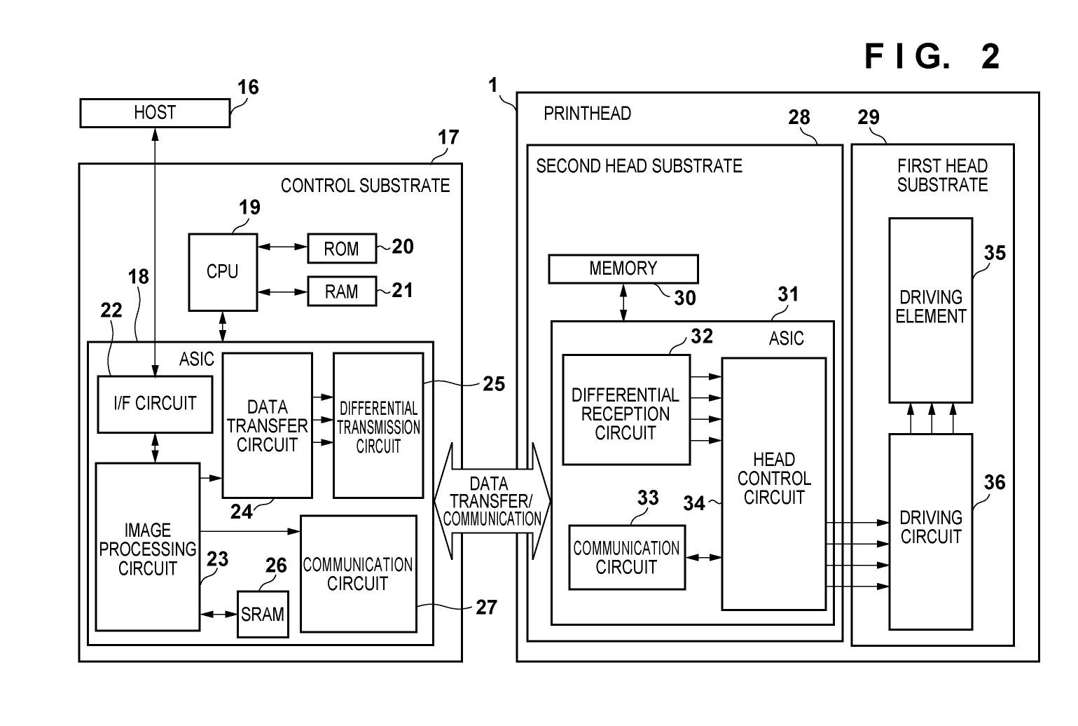

FIG. 2 is a block diagram showing the control arrangement of the printing apparatus shown in FIG. 1.

As shown in FIG. 2, the printhead 1 includes a first head substrate 29 and second head substrate 28. The first head substrate 29 includes a driving element 35 which drives a printing element for printing by discharging ink from a nozzle. The printing element is, for example, an electrothermal transducer (heater). The driving element 35 is, for example, a switching element such as a transistor. To reduce the number of head control signals, an ASIC (Application Specific Integrated Circuit) 31 is mounted on the second head substrate 28, and includes a communication circuit 33 for receiving a serial signal and performing communication between the printhead 1 and a control substrate 17 of the printing apparatus.

An interface (I/F) circuit 22 within an ASIC (Application Specific Integrated Circuit) 18 arranged on the control substrate 17 receives a control command and print data transmitted from a host 16. A CPU 19 analyzes the received control command, and controls the printing apparatus in accordance with the control command. The CPU 19 controls the overall printing apparatus in accordance with a program pre-stored in a ROM 20 and a control command input from the host 16 via the I/F circuit 22. Note that the ROM 20 stores programs for operating the CPU 19, various tables necessary to control the printhead 1, and the like.

Print data received by the interface (I/F) circuit 22 is sent to an image processing circuit 23, undergoes various image processes complying with the printing method, and is temporarily stored in an SRAM 26. The print data stored in the SRAM 26 is read out at a predetermined timing to print, and converted into a serial signal by a data transfer circuit 24. The serial signal is converted into a low voltage differential signal by a differential transmission circuit 25, transmitting the low voltage differential signal to the printhead 1. A communication circuit 27 is used for communication to set the ASIC 31 arranged on the printhead and grasp the state of the printhead 1.

In the printhead 1, a differential signal reception circuit 32 within the ASIC 31 arranged on the second head substrate 28 receives a print data signal transmitted by the low voltage differential signal from the control substrate 17. After the reception, the print data signal is restored to the original level and then transferred to a head control circuit 34. The head control circuit 34 de-serializes the received print data signal and transfers it to a driving circuit 36 of the first head substrate 29. The driving circuit 36 drives the driving element 35 to print.

A memory 30 on the second head substrate 28 holds information in advance such as the use log of the printhead 1 and the characteristics of the driving element 35. The held contents are confirmed and updated by communicating with the communication circuit 27 within the ASIC 18 arranged on the control substrate 17 on the printing apparatus main body side by using the communication circuit 33.

A signal transmission control method regarding transmission/reception of an LVDS (Low Voltage Differential Signal) signal between the printing apparatus and printhead having the above arrangement will be explained.

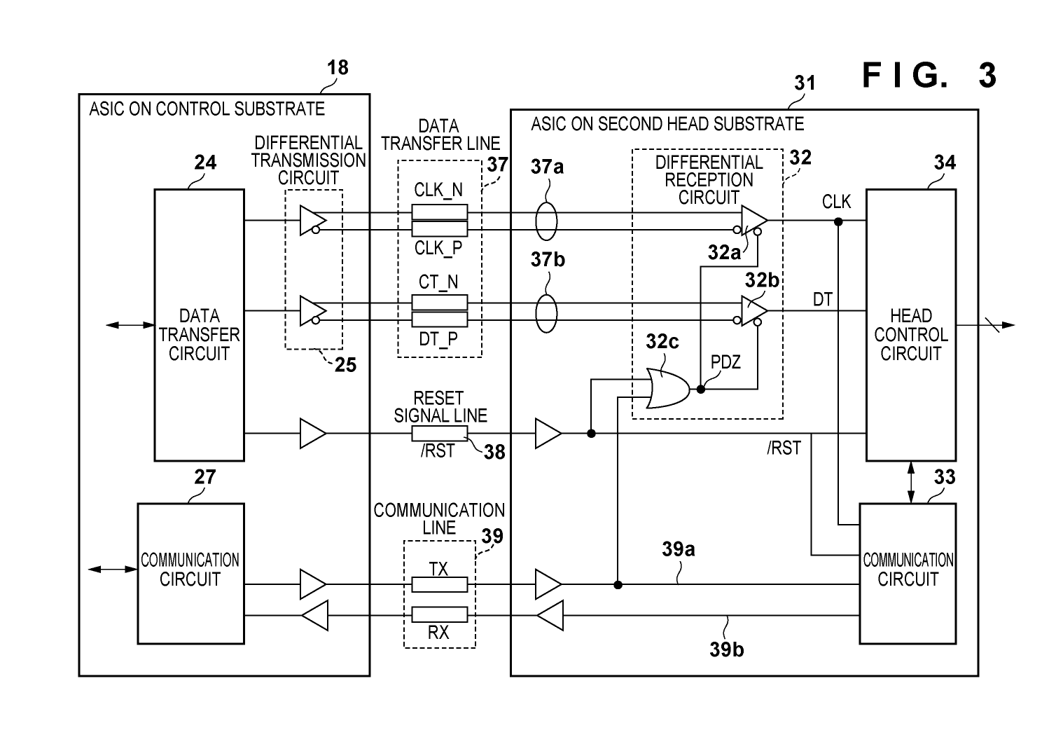

FIG. 3 is a block diagram showing the detailed arrangement of the ASIC 31 of the second head substrate 28 and that of the ASIC 18 of the control substrate 17 on the main body side.

As shown in FIG. 3, the following three signal lines exist between the ASICs 18 and 31: a data transfer line 37 for transferring a print data signal, a reset signal line 38 for controlling reset of the ASIC 31, and a communication line 39 used to set the register and confirm the state by the ASICs 18 and 31. Differential clock signal lines 37a and differential data signal lines 37b will be generically called the data transfer line 37. A transmission communication line 39a and reception communication line 39b will be generically called the communication line 39.

The data transfer circuit 24 converts a print data signal generated in the ASIC 18 into a serial signal. The differential transmission circuit 25 converts the serial signal into a low voltage differential signal, transferring the low voltage differential signal to the ASIC 31 via the data transfer line 37. The transmission signal includes clock signals CLK_N and CLK_P necessary for serial transfer, and data signals DT_N and DT_P. The clock signals CLK_N and CLK_P are transferred via the differential clock signal lines 37a. The data signals DT_N and DT_P are transferred via the differential data signal lines 37b. The clock signals CLK_N and CLK_P used for serial transfer are used for transfer synchronization of data signals and also as the basic operation clock CLK of the ASIC 31.

This arrangement reduces radiation noise and the apparatus cost because no oscillator need be arranged on the substrate on the printhead side to generate a clock signal. The ASIC 18 controls a reset signal /RST in accordance with the operation status of main body control. The communication line 39 is separately arranged between the ASICs 18 and 31 for communication between the memories mounted on them and the ASICs. The ASICs 18 and 31 perform serial communication using the communication line 39. Thus, there are two types of signals, that is, a transmission side signal TX transferred via the transmission communication line 39a and a reception side signal RX transferred via the reception communication line 39b, as shown in FIG. 3.

The differential reception circuit 32 includes low voltage differential buffers 32a and 32b. The low voltage differential buffer used for low voltage differential transmission receives a power-down signal PDZ in consideration of a shipping test and the like. In normal use, the power-down signal PDZ is disabled (high level “1”) so that data transmitted from the outside (in this case, the printing apparatus main body side) can normally propagate inside. In a shipping test for the low voltage differential buffer of the ASIC, the power-down signal PDZ is enabled (low level “0”) to prevent a breakthrough current from flowing inside (in this case, the differential reception circuit of the printhead).

However, when the clock signal of the low voltage differential signal is used as the operation clock signal for the internal circuit of the ASIC of the printhead, the following problem occurs if the de-assertion timing of the power-down signal PDZ and that of reset are made to coincide with each other. That is, immediately after the power-down signal PDZ is de-asserted (negated), the clock signal is not stably supplied to the inside (in this case, the printhead). Hence, when the clock signal is unstable, in a case where reset is de-asserted, in some cases, an operation error might occur.

Considering this, in the embodiment, an arithmetic element (arithmetic circuit) 32c calculates the OR (logical sum) of the reset signal /RST of the ASIC 31 and the transmission side signal TX on the communication line 39 between the ASICs 31 and 18. The logical sum output is then used as the power-down signal PDZ.

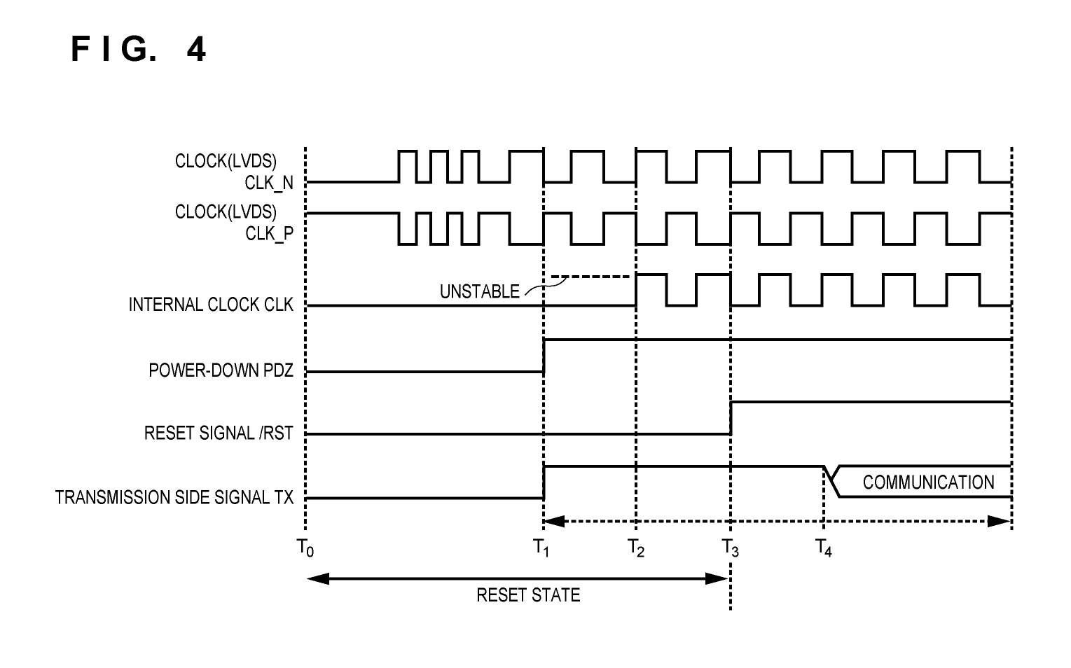

FIG. 4 is a timing chart showing signals transmitted/received via the differential clock signal line 37a, reset signal line 38, and transmission communication line 39a, the power-down signal PDZ output from the arithmetic element (arithmetic circuit) 32c, and the clock signal CLK generated by the differential reception circuit 32. In a period from timing T₀ to timing T₃, the ASIC 31 is in the reset state. In a period from timing T₁ to timing T₂, the clock signal CLK is unstable. In a period after timing T₂, the clock signal CLK is stable.

FIG. 4 shows a case in which the reset signal /RST and the power-down signal PDZ are both at high level “1” in the de-assertion (negation) status. Needless to say, when the logic applied to the reset signal and power-down signal changes, the arranged gate circuit also changes.

With the above-described arrangement, as shown in FIG. 4, the transmission side signal TX changes from low level “0” to high level “1” at timing T₁ to enable the power-down signal PDZ (high level “1”). Timing T₁ is a timing to de-assert (negate) the power-down signal. In a period from timing T₁ to timing T₄, the state of the transmission side signal TX is maintained at high level “1”. After timing T₄, communication is controlled. At the timing when the power-down signal changes to high level, the differential reception circuit 32 starts inputting power. After the start of power input, the reset signal /RST changes from low level “0” to high level “1” at timing T₃ upon the lapse of a predetermined time. In this way, after the clock signal is stably input to the inside (in this case, the printhead), the reset signal /RST can be disabled (high level “1”). The reset signal de-asserts reset within the ASIC 31. Timing T₃ is a timing to disable the reset signal. After de-asserting power-down, reset is de-asserted after a wait for a predetermined time. The data transfer circuit 24 controls to de-assert reset in a period after timing T₂ during which the clock signal CLK stabilizes. After the timing to enable the reset signal, the communication circuit 27 starts communication as control of the transmission side signal TX. The power-down signal PDZ is controlled using the transmission side signal TX for which a signal level before the start of communication is fixed. In this arrangement, the power-down signal PDZ does not change regardless of the state of the transmission side signal TX, so the ASIC 31 can be reset at an appropriate timing. The ASICs 18 and 31 can therefore communicate with each other using the communication line 39. After reset is de-asserted based on input of the reset signal /RST, the communication circuit 33 becomes communicable and communicates with the communication circuit 27 of the ASIC 18.

In this manner, the embodiment controls the power-down signal in consideration of the logical condition for the reset signal of the ASIC and the signal of the separately arranged communication line.

According to the above-described embodiment, the clock signal can be supplied into the printhead to de-assert reset of the ASIC at the timing when an output from the low voltage differential buffer stabilizes, without using a dedicated signal, delay circuit, or the like. After the reset de-assertion, even communication using a signal on the communication line can be performed normally. Note that the embodiment has explained a serial type printing apparatus, but the present invention is also applicable to even a full line type printing apparatus. Further, the present invention is applicable to even a printhead including a piezoelectric element as a printing element. The embodiment has described communication between the ASIC arranged on the printing apparatus main body and the ASIC arranged on the printhead, but the present invention is applicable to even another electronic device. For example, the present invention can be applied to communication between an ASCI arranged in an image reading apparatus main body and an ASIC arranged in a reading head (reading unit). The reading head includes a photoelectric transducer, light-emitting element (LED), and the like. The reading head includes a control circuit for controlling driving of the photoelectric transducer, or a control circuit for controlling driving of the light-emitting element.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-035178, filed Feb. 21, 2011, which is hereby incorporated by reference herein in its entirety.

What is claimed is:

1. A printing apparatus comprising:
a printhead which is connected to the printing apparatus via a communication line, a reset signal line, and a differential signal line, said printhead including a printing element, control circuit for controlling driving of said printing element, arithmetic circuit for performing logical calculation based on a signal received via the communication line and a signal received via the reset signal line, and generation circuit for supplying a clock signal to be transferred to said control circuit based on a differential clock signal received via the differential signal line and an output from said arithmetic circuit;
a first transmission unit configured to output a control signal in a first predetermined period before transmitting data to said control circuit via the communication line; and
a second transmission unit configured to transmit a reset signal for de-asserting a reset state of said control circuit, via the reset signal line a second predetermined period after said first transmission unit outputs the control signal.

2. The apparatus according to claim 1, wherein the clock signal is used as an operation clock signal of said control circuit.

3. The apparatus according to claim 1, wherein said first transmission unit and said second transmission unit are contained in an ASIC on a control substrate of the printing apparatus.

4. The apparatus according to claim 1, wherein the printhead includes:
a first head substrate including a driving element which drives said printing element, and a driving circuit for driving said driving element; and
a second head substrate including said control circuit, said arithmetic circuit, and said generation circuit.

5. The apparatus according to claim 4, wherein said printing element includes a heater, and said driving element includes a switching element.

6. An electronic device comprising:
a driving unit which is connected to the electronic device via a communication line, a reset signal line, and a differential signal line, said driving unit including a driving element, control circuit for controlling driving of said driving element, arithmetic circuit for performing logical calculation based on a signal received via the communication line and a signal received via the reset signal line, and generation circuit for supplying a clock signal to be transferred to said control circuit based on a differential clock signal received via the differential signal line and an output from said arithmetic circuit;
a first transmission unit configured to output a control signal in a first predetermined period before transmitting data to said control circuit via the communication line; and
a second transmission unit configured to transmit a reset signal for de-asserting a reset state of said control circuit, via the reset signal line a second predetermined period after said first transmission unit outputs the control signal.

7. The device according to claim 6, wherein said driving element includes a photoelectric transducer or a light-emitting element.
